(19) United States
(12) Patent Application Publication
(10) Pub. No.: US 2023/0237629 A1
(43) Pub. Date: Jul. 27, 2023

(54) METHOD AND APPARATUS FOR GENERATING FACE HARMONIZATION IMAGE

(71) Applicant: ELECTRONICS AND TELECOMMUNICATIONS RESEARCH INSTITUTE, Daejeon (KR)

(72) Inventors: Juwon LEE, Daejeon (KR); Jung Jae YU, Daejeon (KR); Wonyoung YOO, Daejeon (KR)

(21) Appl. No.: 18/077,434

(22) Filed: Dec. 8, 2022

(30) Foreign Application Priority Data
Jan. 26, 2022 (KR) 10-2022-0011557

(51) Int. Cl. G06T 5/50; G06V 40/16; G06T 7/11; G06T 3/00

(52) U.S. Cl. CPC G06T 5/50; G06V 40/171; G06T 7/11; G06T 3/0068; G06T 3/0093; G06T 2207/30201; G06T 2207/20221

(57) ABSTRACT

A method and apparatus for generating a face-harmonized image are disclosed. The method of generating a face-harmonized image includes receiving an input image, extracting facial landmarks from a target image and the input image, generating a face-removed image of the target image based on a facial mask region, extracting a user face image from the input image, transforming the user face image to correspond to the facial mask region, generating a face-blended image by blending the transformed user face image with the target image, extracting a feature map of the face-blended image, generating a combined feature map based on the feature map of the face-blended image and a feature map of the target image, generating a face harmonization result image based on the combined feature map, and providing the generated face harmonization result image.

### CROSS-REFERENCE TO RELATED APPLICATION

This application claims the benefit of Korean Patent Application No. 10-2022-0011557 filed on Jan. 26, 2022, in the Korean Intellectual Property Office, the entire disclosure of which is incorporated herein by reference for all purposes.

### BACKGROUND

### 1. Field of the Invention

One or more example embodiments relate to a technology for generating a face-harmonized image.

### 2. Description of Related Art

A harmonized image generation technology may harmonize or combine different images by, for example, combining an entire first image and an entire second image or combining an object extracted from the second image with the first image. In general, such an image harmonization technology may be used to reconstruct a single image having all features of two or more images having different features. The image harmonization technology may be applied to various fields, for example, to improve the resolution of an image, generate an image in which objects are combined, or analyze an image.

### SUMMARY

According to an aspect, there is provided a method of generating a face-harmonized image, the method including: receiving an input image; extracting facial landmarks from a target image and the input image; generating a face-removed image of the target image using a facial mask generated from facial landmarks; extracting a user face image from the input image; transforming the user face image to correspond to the facial mask region of a target image ; generating a face-blended image by blending the transformed user face image with the target image; extracting a feature map of the face-blended image; generating a combined feature map based on the feature map of the face-blended image and a feature map of the target image; generating a face harmonization result image based on the combined feature map; and providing the generated face harmonization result image.

The target image may include an image of an artwork displayed in an exhibition hall, and the input image may include an image of a user including a visitor to the exhibition hall.

When there is another object in a facial region in the target image, the generating of the face-removed image of the target image including the facial mask region may include extracting the other object from the facial region; and storing the extracted other object.

When there is another object in the facial region in the target image, the generating of the face-blended image by blending the transformed user face image with the target image may include generating the face-blended image including the other object by placing, to the face-blended image, the extracted other object.

When there is another object in the facial region in the target image, the extracting of the other object from the facial region may include receiving a user input for segmenting the other object.

The extracting of the facial landmarks from the target image and the input image may include extracting the same number of corresponding facial landmarks from the target image and the input image, respectively.

The transforming of the user face image to correspond to the facial mask region of a target image may include generating the first triangulation based on the extracted facial landmarks; generating the second triangulation based on the extracted facial landmarks of the target image; and extracting first triangular patches based on the first triangulation and second triangular patches based on the second triangulation.

The generating of the face-blended image by blending the transformed user face image with the target image may include performing affine warping based on a set of the first triangular patches and a set of the second triangular patches; generating the face-blended image based on a set of first triangular patches obtained by the affine warping and the face-removed image of the target image; and correcting a boundary surface and a tone of the generated face-blended image.

The performing of the affine warping based on the set of the first triangular patches and the set of the second triangular patches may include performing the affine warping on at least one of an entirety or a portion of the set of the first triangular patches.

The generating of the combined feature map based on the feature map of the face-blended image and the feature map of the target image may include adding, elementwise, feature values corresponding to coordinates corresponding to the facial mask region of the target image and corresponding feature values of the feature map of the target image.

The generating of the combined feature map based on the feature map of the face-blended image and the feature map of the target image may include adjusting an intensity by which a face is applied to the target image based on a weight for each of the feature maps.

The generating of the combined feature map based on the feature map of the face-blended image and the feature map of the target image may include concatenating the two feature maps to generate a feature map in which the number of channels is doubled.

According to another aspect, there is provided an apparatus for generating a face-harmonized image, the apparatus including: a camera configured to obtain an input image; a storage configured to store information on a target image to be harmonized with the obtained input image; a processor configured to extract facial landmarks from the target image and the input image, generate a face-removed image of the target image using a facial mask generated from facial landmarks, extract a user face image from the input image, transform the user face image to correspond to the facial mask region, generate a face-blended image by blending the transformed user face image with the target image, extract a feature map of the face-blended image, generate a combined feature map based on the feature map of the face-blended image and a feature map of the target image, and generate a face harmonization result image based on the combined feature map; and a display configured to provide the generated face harmonization result image to a user.

When there is another object in a facial region in the target image, the processor may extract the other object from the facial region and store the extracted other object.

When there is another object in a facial region in the target image, the processor may placing, to the face-blended image, the other object that is extracted, and generate the face-blended image including the other object.

The processor may generate first triangulation based on the extracted facial landmarks; generate second triangulation based on the extracted facial landmarks of the target image; and extract first triangular patches based on the first triangulation and second triangular patches based on the second triangulation.

The processor may perform affine warping based on a set of the first triangular patches and a set of the second triangular patches; generate the face-blended image based on a set of first triangular patches obtained by the affine warping and the face-removed image of the target image; and correct a boundary surface and a tone of the generated face-blended image.

The processor may adjust an intensity by which a face is applied to the target image based on a weight for each of the feature maps.

The processor may generate the combined feature map by adding, elementwise, feature values corresponding to coordinates corresponding to the facial mask region of the target image and corresponding feature values of the feature map of the target image.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating an example of generating a face-harmonized image according to an example embodiment;

FIG. 2 is a diagram illustrating an example of preprocessing a target image according to an example embodiment;

FIG. 3 is a flowchart illustrating an example of a method of generating a face-blended image according to an example embodiment;

FIG. 4 is a flowchart illustrating an example of a method of generating and correcting a face-blended image according to an example embodiment;

FIGS. 5A and 5B are diagrams illustrating an example of preprocessing a target image according to an example embodiment;

FIGS. 6A and 6B are diagrams illustrating an example of preprocessing an input image and an example of a face-blended image according to an example embodiment; and

FIG. 7 is a block diagram illustrating an example of a configuration of an apparatus for generating a face-harmonized image according to an example embodiment.

### DETAILED DESCRIPTION

The following detailed structural or functional description is provided as an example only and various alterations and modifications may be made to the examples. Here, the examples are not construed as limited to the disclosure and should be understood to include all changes, equivalents, and replacements within the idea and the technical scope of the disclosure.

Terms, such as first, second, and the like, are used herein to describe components. These terms are used only to distinguish one component from another component. For example, a first component may be referred to as a second component, or similarly, the second component may also be referred to as the first component.

It should be noted that if it is described that one component is “connected,” “coupled,” or “joined” to another component, a third component may be “connected,” “coupled,” and “joined” between the first and second components, although the first component may be directly connected, coupled, or joined to the second component.

The singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in this specification, specify the presence of stated features, integers, steps, operations, elements, components, or a combination thereof, but do not preclude the presence or addition of one or more other features, integers, steps, operations, elements, components, and/or groups thereof.

Unless otherwise defined herein, all terms used herein including technical or scientific terms have the same meanings as those generally understood by one of ordinary skill in the art to which this disclosure pertains. Terms, such as those defined in generally used dictionaries, are to be construed to have meanings that are consistent with contextual meanings in the related art and are not to be construed as ideal or excessively formal meanings unless otherwise defined herein.

Hereinafter, example embodiments will be described in detail with reference to the accompanying drawings. When describing the example embodiments with reference to the accompanying drawings, like reference numerals refer to like components and a repeated description related thereto will be omitted.

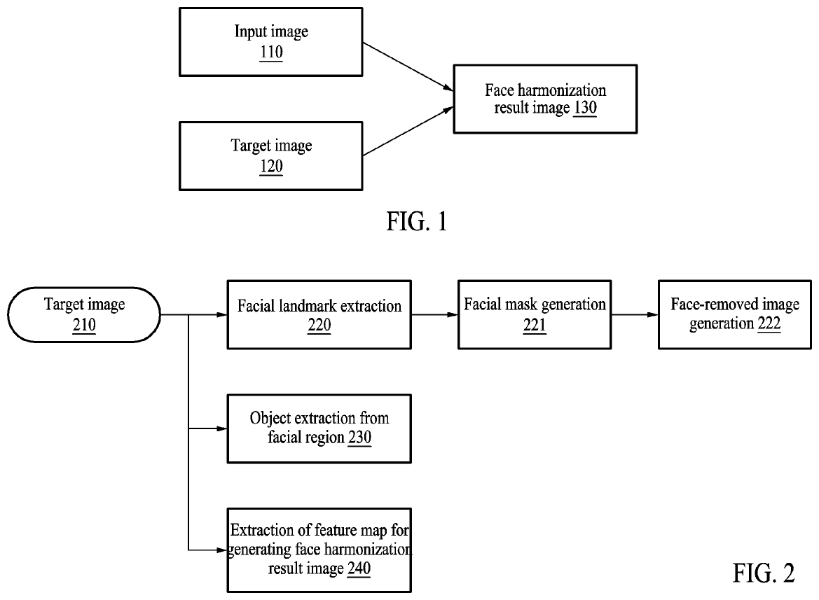

FIG. 1 is a diagram illustrating an example of generating a face-harmonized image according to an example embodiment.

Unlike style transfer by which an entire actual input image is applied to the texture, color, and style of a target image, image harmonization-based image generation may be a method of blending a specific region of interest (ROI), not the entire actual input image, with the target image and adjusting it not to be harmonized in terms of the text, color, and the like of the target image. According to example embodiments described herein, there is provided a method that may maintain the same pose and same shape of a face in an input image and a target image by considering deformation of an object, unlike a typical image harmonization-based image generation method. This method may be applied to hands-on experience exhibitions for visitors to art exhibition halls such as art museums. For example, in art exhibition halls, even when a person in an input image changes or even when only a single image or a few images of a person is available, this method may be applied to provide visitors with chances to see a harmonized or combined image in which their faces and exhibited artworks are harmonized or combined.

Referring to FIG. 1, a face harmonization result image 130 may be generated by harmonizing an input image 110 obtained from a user or received by other methods with a target image 120 that is a target of image harmonization-based image generation used to generate a harmonized image.

According to an example embodiment, the input image 110 may include a user image including a visitor to an exhibition hall. The target image 120 may include an artwork image including a work displayed in the exhibition hall such as an art museum.

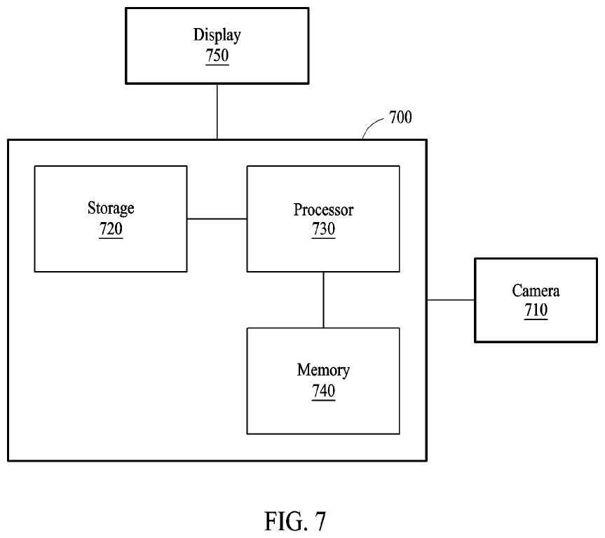

According to an example embodiment, an apparatus for generating a face-harmonized image (e.g., an apparatus 700 of FIG. 7) described herein may generate the face harmonization result image 130 by harmonizing the input image 110 and the target image 120. The apparatus may receive the input image 110 and extract facial landmarks from each of the target image 120 and the input image 110. The apparatus may generate a facial mask based on the facial landmarks extracted from the target image 120 including a facial region, generate a face-removed image based on the facial mask, and extract a user face image based on the facial landmarks extracted from the input image 110. The apparatus may transform the user face image to correspond to the facial mask region and harmonize (or blend) the transformed user face image with the target image 120 to generate a face-blended image. The apparatus may then extract a feature map of the face-blended image, generate a combined feature map based on the feature map of the face-blended image and a feature map of the target image 120, and generate the face harmonization result image 130 based on the combined feature map. The generated face harmonization result image 130 may be provided to a user through a display or the like.

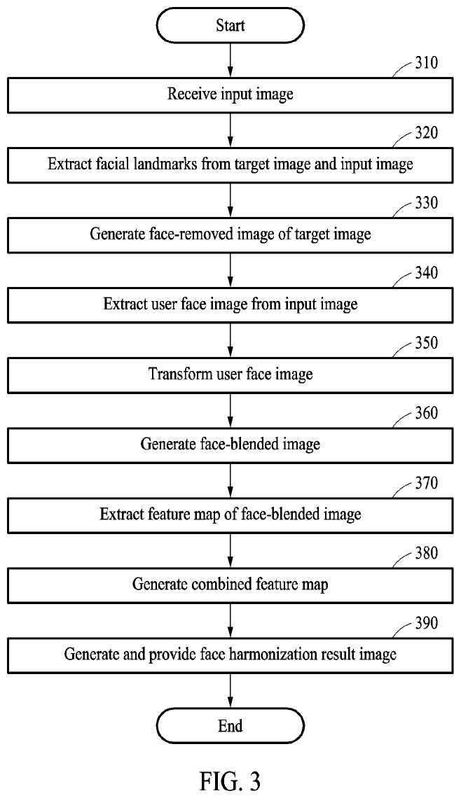

FIG. 2 is a diagram illustrating an example of preprocessing a target image according to an example embodiment. The preprocessing described below with reference to FIG. 2 may be performed by an apparatus for generating a face-harmonized image (e.g., an apparatus 700 of FIG. 7) described herein.

Referring to FIG. 2, preprocessing a target image 210 may include a facial landmark extraction process 220 of extracting major facial feature points (or facial landmarks herein) included in an exhibition image corresponding to the target image 220, a facial mask generation process 221, and a face-removed image generation process 222. The preprocessing of the target image 210 may also include an object extraction process 230 of extracting an object in a facial region and a feature map extraction process 240 for generating a face harmonization result image, which may be performed temporally simultaneously with the foregoing processes.

The facial landmark extraction process 220 may include automatically extracting the facial landmarks (e.g., points that define tips of eyes, nose, lips, and eyebrows, a facial contour, and the like) using various facial landmark detectors, such as, for example, a face alignment with an ensemble of regression trees, a style aggregated network for facial landmark detection, or the like. The facial landmark extraction process 220 may be performed by extracting the facial landmarks from the same positions in a face using a test database (DB) used in a technique, such as, for example, 300 Faces in-the-Wild Challenge (300-W).

The facial landmark extraction process 220 may include correcting a landmark extraction result by the user when a result of extracting the facial landmarks is incorrect, or extracting landmarks directly by the user from the beginning. To this end, the facial landmark extraction process 220 may include receiving a user input for extracting landmarks from the target image 210. The facial mask generation process 221 may be performed based on the landmarks extracted in the facial landmark extraction process 220. The facial mask generation process 221 may include finding a convex hull based on the extracted landmarks. In the face-removed image generation process 222, a face-removed image obtained by removing a face from the target image 210 may be generated using the generated facial mask.

The object extraction process 230 of extracting another object in the facial region of the target image 210 may include extracting another object from the facial region when the other object is present in the facial region of the target image 210, and storing the extracted other object. The object extraction process 230 of extracting another object in the facial region may include segmenting various objects, for example, hair, hand, accessory, hat, musical instrument, or the like, that are not the face included in the facial region of a person in the target image 210 from the face. The objects to be segmented in the object extraction process 230 may correspond to a region to be removed in a process of blending a face of a visitor with the face of the person in the target image 210, and may thus be segmented before the harmonization-based image generation and then be stored in a separate layer to be blended in a user face in an input image blende to target image. Through this, a content of an original target image may be maintained so as not to be removed. For example, the object extraction process 230 of extracting another object in the facial region may include automatically segmenting the object using a semantic segmentation, object segmentation, or image matting model.

In the object extraction process 230 of extracting another object in the facial region, a model trained based on an actual image (e.g., a photo) may be used without a change, and a model trained with a painting image may be used to increase accuracy.

In addition, the object extraction process 230 may include receiving a user input, for example, manually extracting another object in the face directly by the user, to obtain a more accurate result. In the object extraction process 230 of extracting an object in the facial region, the extracted other object may be blended in the harmonization target image with which the user face in an input image blended after being stored in a separate layer. Through this, the original content of target image for harmonization may be maintained so as not to be removed. The other object may be applied in a process of generating a face-blended image including the object.

In the feature map extraction process 240 for generating a face harmonization result image, a feature map of the target image 210 may be extracted. The extracted feature map of the target image 210 may be used to combine feature maps based on a mask after the face-blended image is generated. In the feature map extraction process 240 for generating a face harmonization result image, various models used as encoders in an artificial neural network-based generation model such as VGGNet and ResNet may be used to extract a feature map.

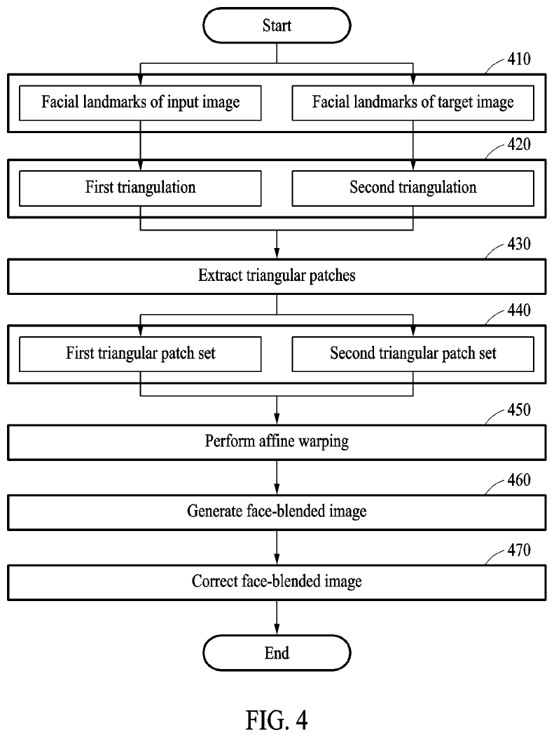

FIG. 3 is a flowchart illustrating an example of a method of generating a face-harmonized image according to an example embodiment. Operations described below with reference to FIG. 3 may be performed by an apparatus (e.g., an apparatus 700 of FIG. 7) for generating a face-harmonized image described herein. Referring to FIG. 3, in operation 310, the apparatus may receive an input image from a user. The input image may be obtained through a camera, a sensor, or the like provided in a kiosk, a photobox, or the like for a hands-on experience exhibition for visitors.

In operation 320, the apparatus may extract facial landmarks from a target image and the input image. Operation 320 may include extracting the same number of corresponding facial landmarks from the target image and the input image, respectively.

In operation 330, the apparatus may generate a face-removed image of the target image. Operation 330 may include generating the face-removed image of the target image based on the facial landmarks extracted from the target image.

In operation 340, the apparatus may extract a user face image from the input image. Operation 340 may include extracting the user face image based on the facial landmarks extracted from the input image.

In operation 350, the apparatus may transform the user face image. Operation 350 may include transforming a triangular patch of the user face image into a coordinate system of a corresponding triangular patch of the target image.

In operation 360, the apparatus may generate a face-blended image by blending the target image and the transformed user face image. Operation 360 may include blending a face in the input image with a face in the target image based on the input image including a visitor and the facial landmarks of the input image and on the target image and the facial landmarks of the target image. For example, a face in an input image and an object in a facial region in the target image may be blended in operation 360. For example, when there is an object in the facial region in the target image, operation 360 may include applying the object that is segmented in advance and stored in a separate layer.

In operation 370, the apparatus may extract a feature map of the face-blended image. In operation 370 of extracting the feature map of the face-blended image, various models used as encoders in artificial neural network-based generation models such as VGGNet and ResNet may be used to extract the feature map. In addition, the extraction of the feature map of the face-blended image may be performed using the same model as a model extracting a feature map of the target image.

In operation 380, the apparatus may combine the feature maps based on a mask. Operation 380 may include adding, elementwise, feature values of an image in which the user's face is blended in the target image corresponding to coordinates corresponding to a facial mask region of the target image and feature values corresponding to the feature map of the target image to generate a combined feature map based on the feature map of the face-blended image and the feature map of the target image. Operation 380 may include adjusting an intensity by which the face in an input image is applied to the target image based on a weight for each feature map to generate the combined feature map based on the feature map of the face-blended image and the feature map of the target image. Operation 380 may include multiplying, elementwise, the feature values of an image in which the user's face is blended in the target image corresponding to the coordinates corresponding to the facial mask region of the target image and the feature values corresponding to the feature map of the target image to generate the combined feature map based on the feature map of the face-blended image and the feature map of the target image. Operation 380 may include concatenating the two feature maps to generate a feature map in which the number of channels is doubled, to generate the concatenated feature map based on the feature map of the face-blended image and the feature map of the target image.

In operation 390, the apparatus may generate a face harmonization result image and provide the generated face harmonization result image to the user. Operation 390 may include generating the face harmonization result image from the combined feature map by using a harmonization generation model. The harmonization generation model may be, for example, a model based on element-embedded style transfer networks for style harmonization (E2STN) that is known in the art to which the disclosure pertains.

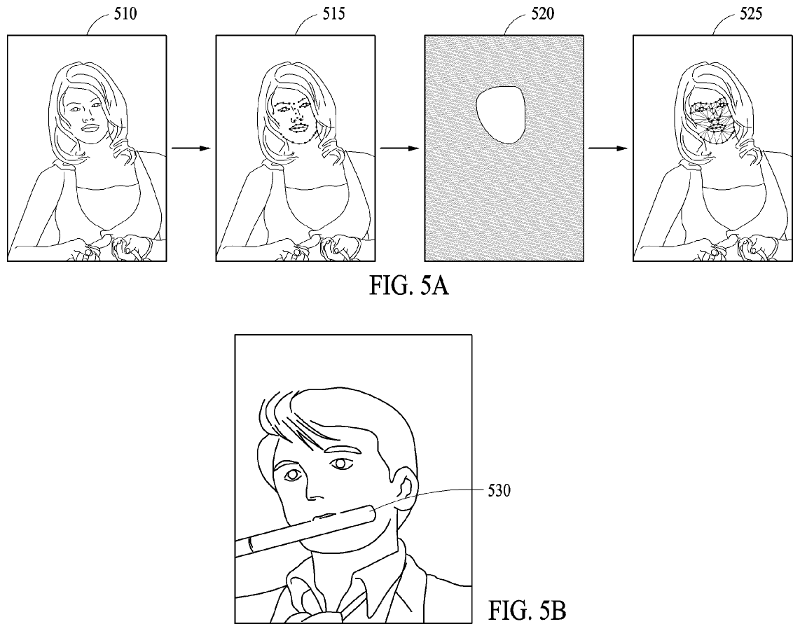

FIG. 4 is a flowchart illustrating an example of a method of generating and correcting a face-blended image according to an example embodiment.

Referring to FIG. 4, in operation 410, facial landmarks of an input image and facial landmarks of a target image may be detected, as described above with reference to FIGS. 2 and 3.

In operation 420, triangulation may be performed. Operation 420 of performing the triangulation may include performing first triangulation based on the facial landmarks in the input image and performing second triangulation based on the facial landmarks in the target image.

In operation 430, triangular patches may be extracted. Operation 430 of extracting the triangular patches may include, after operation 420 of performing the triangulation, extracting corresponding triangular patches according to indices of the facial landmarks based on the first triangulation and the second triangulation.

In operation 440, triangular patch sets may be formed based on the extracted triangular patches. Operation 440 of forming the triangular patch sets based on the extracted triangular patches may include forming a first triangular patch set based on facial triangular patches in the input image and a second triangular patch set based on facial triangular patches in the target image.

In operation 450, affine transformation (e.g., affine warping) may be performed. The affine warping may be performed on all the first triangular patches, or may be partially performed on a specific region, such as, for example, an eye region, a mouth region, and the like of the first triangular patches.

In operation 460, a face-blended image may be generated. Operation 460 of generating the face-blended image may include generating the face-blended image based on a first triangular patch set obtained through the affine warping and a face-removed image of the target image.

In operation 470, the face-blended image may be corrected. Operation 470 of correcting the face-blended image may include correcting a boundary surface and a tone of the face-blended image generated in operation 460 by performing post-correction to allow the image to be shown more natural.

In operation 470 of correcting the face-blended image, a Poisson image editing algorithm that is known in the art to which the disclosure pertains, for example, may be used to correct the boundary surface and the tone.

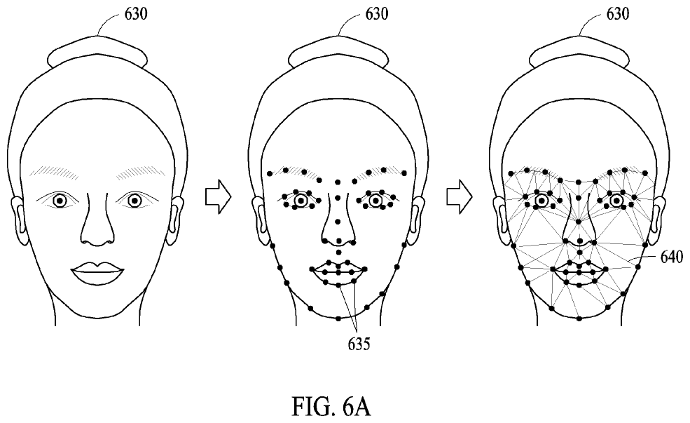

FIGS. 5A and 5B are diagrams illustrating an example of preprocessing a target image according to an example embodiment.

Referring to FIG. 5A, an image 515 in which the facial landmarks may be automatically extracted from a target image 510 in which a target person of a face harmonization result image is shown, or an image 515 in which the facial landmarks are extracted manually may be obtained. The facial landmarks may be obtained based on eyes, nose, and mouth of the person in the target image 510. A facial mask may be generated based on the extracted facial landmarks, and a facial mask image 520 of a portion in which a face is positioned in the target image 510 may be obtained. To generate a face-blended image, an image 525 obtained by triangulation based on the facial landmarks may be obtained.

Referring to FIG. 5B, there may be a pipe 530 in a facial region of a person in a target image. The pipe 530 may correspond to an object in the facial region of the person in the target image. The pipe 530 may be extracted after being detected, and may then be stored in a separate layer to generate a face-blended image. The stored pipe 530 may be applied to generate a face-blended image. Through this, it is possible to provide a user with a face-blended image showing a person in an input image play the pipe 530 .

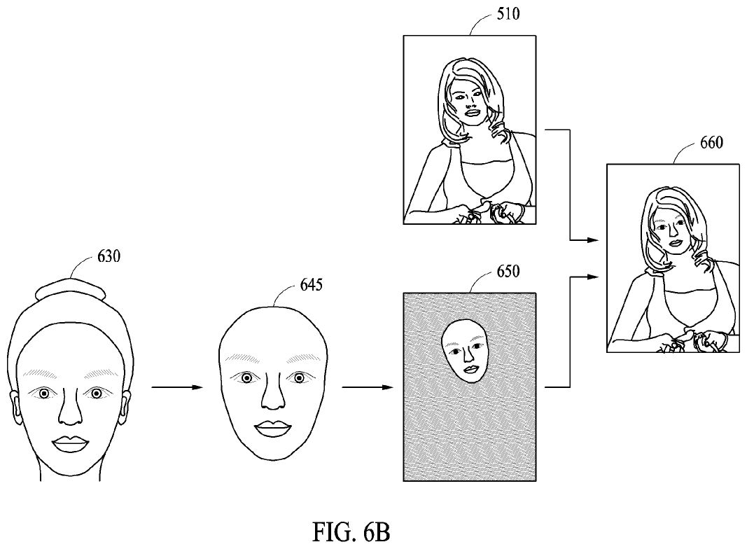

FIGS. 6A and 6B are diagrams illustrating an example of preprocessing an input image and an example of a face-blended image according to an example embodiment.

Referring to FIGS. 6A and 6B, facial landmarks 635 of a person in an input image 630 may be detected based on the input image 630, and triangulation 640 may be performed on a face of the person based on the extracted facial landmarks 635. Thereafter, affine warping may be performed on in a segmented facial region 645 of the person in an input image based on a pose and angle of a face of a person in a target image 510. A face 650 of the person in the input image that is obtained through the affine warping may be shown with the head tilted in the same direction as a direction of the head of the person in the target image 510. A face-blended image 660 may be generated through blend of the target image 510 and the face 650 of the person in the input image obtained through the affine warping.

FIG. 7 is a block diagram illustrating an example of a configuration of an apparatus for generating a face-harmonized image according to an example embodiment.

Referring to FIG. 7, an apparatus 700 for generating a face-harmonized image may include a storage 720, a processor 730, and a memory 740. According to an embodiment, the apparatus 700 may further include a camera 710 for obtaining an input image and a display 750 for outputting a face-harmonized image.

The apparatus 700 may perform the method of generating a face-harmonized image described above with reference to FIGS. 1 to 6B. According to an example embodiment, the apparatus 700 may be, for example, a computing device for generating a face-harmonized image, a server, or a user terminal in which an application or web related to the method of generating a face-harmonized image is executed or installed.

The memory 740 may be connected to the processor 730, and store instructions executable by the processor 730, data to be processed by the processor 730, or data processed by the processor 730. The memory 740 may include a non-transitory computer readable medium, for example, a high-speed random-access memory (RAM), and/or a nonvolatile computer-readable storage medium (e.g., one or more disk storage devices, flash memory devices, or other nonvolatile solid state memory devices).

The storage 720 may store information on one or more input images and target images.

The display 750 may display a screen of the application or web related to the method of generating a face-harmonized image. The display 750 may display a generated result image (e.g., a face-harmonized image) obtained through harmonization and provide it to a user.

The camera 710 may obtain an input image.

The processor 730 may control the apparatus 700 to perform one or more of the operations of the apparatus for generating a face-harmonized image described herein. For example, the processor 730 may control the apparatus 700 to perform the following operations. The processor 730 may obtain an input image from a user and extract feature points (or facial landmarks herein) from a target image and the input image. The processor 730 may generate a face-removed image of the target image using a facial mask generated from facial landmarks and extract a user face image from the input image. The processor 730 may transform the user face image to correspond to the facial mask region and harmonize the transformed user face image with the target image to generate a face-blended image. The processor 730 may extract a feature map of the face-blended image and generate a combined feature map based on the feature map of the face-blended image and a feature map of the target image. The processor 730 may generate a face harmonization result image based on the combined feature map and provide the generated face harmonization result image to the user. The processor 730 may generate the combined feature map by adding, elementwise, feature values of an image in which the user's face is blended in the target image corresponding to coordinates corresponding to the facial mask region of the target image and corresponding feature values of the feature map of the target image.

For example, when there is another object in a facial region of the target image, the processor 730 may extract the object from the facial region and store the extracted object. When the object is detected in the facial region of the target image, the processor 730 may generate a face-blended image including the object by applying the detected object to the face-blended image. According to an example embodiment, the processor 730 may receive a user input for segmenting an object.

According to an example embodiment, the processor 730 may extract the same number of corresponding feature points from the target image and the input image, respectively. For example, the processor 730 may generate first triangulation based on the extracted (or detected) facial landmarks and generate second triangulation based on the facial landmarks of the target image. The processor 730 may extract first triangular patches based on the first triangulation and extract second triangular patches based on the second triangulation. The processor 730 may perform affine transformation (e.g., affine warping) based on a first triangular patch set (which is a set of the first triangular patches) and a second triangular patch set (which is a set of the second triangular patches), and may generate the face-blended image based on a first triangular patch set obtained through the affine warping and the face-removed image of the target image. The processor 730 may correct a boundary surface and a tone of the generated face-blended image. The processor 730 may perform the affine warping on at least one of an entirety or a portion of the first triangular patch set and the second triangular patch set.

The processor 730 may generate a combined feature map by adding, elementwise, feature values of an image in which the user's face is blended in the target image corresponding to coordinates corresponding to the facial mask region of the target image and corresponding feature values of the feature map of target image. The processor 730 may adjust an intensity by which the face in an input image is applied to the target image based on a weight for each feature map. The processor 730 may generate the combined feature map by multiplying, elementwise, the feature values of an image in which the user's face is blended in the target image corresponding to the coordinates corresponding to the facial mask region of the target image and the corresponding feature values of the feature map of the target image. The processor 730 may concatenate the two feature maps to generate a feature map in which the number of channels is doubled.

The units described herein may be implemented using a hardware component, a software component, and/or a combination thereof. A processing device may be implemented using one or more general-purpose or special-purpose computers, such as, for example, a processor, a controller, an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as, parallel processors.

The software may include a computer program, a piece of code, an instruction, or some combination thereof, to independently or collectively instruct or configure the processing device to operate as desired. The software and data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software is stored and executed in a distributed fashion. The software and data may be stored by one or more non-transitory computer-readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random-access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

While this disclosure includes specific example embodiments, it will be apparent to one of ordinary skill in the art that various changes in form and details may be made in these example embodiments without departing from the spirit and scope of the claims and their equivalents. The example embodiments described herein are to be considered in a descriptive sense only, and not for purposes of limitation. Descriptions of features or aspects in each example embodiment are to be considered as being applicable to similar features or aspects in other example embodiments. Suitable results may be achieved if the described techniques are performed in a different order, and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A method of generating a face-harmonized image, comprising:
receiving an input image;
extracting facial landmarks from a target image and the input image;
generating a face-removed image of the target image based on a facial mask region;
extracting a user face image from the input image;
transforming the user face image to correspond to the facial mask region;
generating a face-blended image by blending the transformed user face image with the target image;
extracting a feature map of the face-blended image;
generating a combined feature map based on the feature map of the face-blended image and a feature map of the target image;
generating a face harmonization result image based on the combined feature map; and
providing the generated face harmonization result image.

2. The method of claim 1, wherein the target image comprises an image of an artwork displayed in an exhibition hall, and
the input image comprises an image of a user including a visitor to the exhibition hall.

3. The method of claim 1, wherein, when there is another object in a facial region in the target image, the generating of the face-removed image of the target image comprising the facial mask region comprises:
extracting the other object from the facial region; and
storing the extracted other object.

4. The method of claim 1, wherein, when there is another object in a facial region in the target image, the generating of the face-blended image by blending the transformed user face image with the target image comprises:
generating the face-blended image including the other object by applying, to the face-blended image, the other object that is extracted.

5. The method of claim 3, wherein, when there is another object in the facial region in the target image, the extracting of the other object from the facial region, comprises:
receiving a user input for segment the other object.

6. The method of claim 1, wherein the extracting of the facial landmarks from the target image and the input image comprises:
extracting the same number of corresponding facial landmarks from the target image and the input image, respectively.

7. The method of claim 1, wherein the transforming of the user face image to correspond to the facial mask region comprises:
generating first triangulation based on the extracted facial landmarks;
generating second triangulation based on the extracted facial landmarks of the target image; and
extracting first triangular patches based on the first triangulation and second triangular patches based on the second triangulation.

8. The method of claim 7, wherein the generating of the face-blended image by blending the transformed user face image with the target image comprises:
performing affine warping based on a set of the first triangular patches and a set of the second triangular patches;
generating the face-blended image based on a set of first triangular patches obtained by the affine warping and the face-removed image of the target image; and
correcting a boundary surface and a tone of the generated face-blended image.

9. The method of claim 8, wherein the performing of the affine warping based on the set of the first triangular patches and the set of the second triangular patches comprises:
performing the affine warping on at least one of an entirety or a portion of the set of the first triangular patches.

10. The method of claim 1, wherein the generating of the combined feature map based on the feature map of the face-blended image and the feature map of the target image comprises:
adding, elementwise, feature values of an image in which the user's face is blended in the target image corresponding to coordinates corresponding to the facial mask region of the target image and corresponding feature values of the feature map of the target image.

11. The method of claim 1, wherein the generating of the combined feature map based on the feature map of the face-blended image and the feature map of the target image comprises:
adjusting an intensity by which a face in an input image is applied to the target image based on a weight for each of the feature maps.

12. The method of claim 1, wherein the generating of the combined feature map based on the feature map of the face-blended image and the feature map of the target image comprises:
concatenating the two feature maps to generate a feature map in which the number of channels is doubled.

13. An apparatus for generating a face-harmonized image, comprising:
a camera configured to obtain an input image;
a storage configured to store information on a target image to be harmonized with the obtained input image;
a processor configured to extract facial landmarks from the target image and the input image, generate a face-removed image of the target image using a facial mask generated from facial landmarks, extract a user face image from the input image, transform the user face image to correspond to the facial mask region, generate a face-blended image by blending the transformed user face image with the target image, extract a feature map of the face-blended image, generate a combined feature map based on the feature map of the face-blended image and a feature map of the target image, and generate a face harmonization result image based on the combined feature map; and
a display configured to provide the generated face harmonization result image to a user.

14. The apparatus of claim 13, wherein the processor is configured to:
when there is another object in a facial region in the target image, extract the other object from the facial region and store the extracted other object.

15. The apparatus of claim 13, wherein the processor is configured to:
when there is another object in a facial region in the target image, apply, to the face-blended image, the other object that is extracted, and generate the face-blended image including the other object.

16. The apparatus of claim 13, wherein the processor is configured to:
generate first triangulation based on the extracted facial landmarks;
generate second triangulation based on the extracted facial landmarks of the target image; and
extract first triangular patches based on the first triangulation and second triangular patches based on the second triangulation.

17. The apparatus of claim 16, wherein the processor is configured to:
perform affine warping based on a set of the first triangular patches and a set of the second triangular patches;
generate the face-blended image based on a set of first triangular patches obtained by the affine warping and the face-removed image of the target image; and
correct a boundary surface and a tone of the generated face-blended image.

18. The apparatus of claim 13, wherein the processor is configured to:
adjust an intensity by which a face in an input image is applied to the target image based on a weight for each of the feature maps.

19. The apparatus of claim 13, wherein the processor is configured to:
generate the combined feature map by adding, elementwise, feature values of an image in which the user's face is blended in the target image corresponding to coordinates corresponding to the facial mask region of the target image and corresponding feature values of the feature map of the target image.
